(19) United States
(12) Patent Application Publication
(10) Pub. No.: US 2009/0327040 A1
(43) Pub. Date: Dec. 31, 2009

(54) Systems and methods for identifying business opportunities

(75) Inventor: Jeffrey Francis McInerny, Washington, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/216,112

(22) Filed: Jun. 30, 2008

(51) Int. Cl. G06Q 10/00

(52) U.S. Cl. 705/10

(57) ABSTRACT

Systems and methods are disclosed for identifying a business opportunity in a target market. In one embodiment, a business may implement a method to define a target market based on one or more business characteristics. The method may include receiving a first set of company data for companies associated with the target market and building an industry profile associated with the target market based on the first set of company data. The method may also include generating a second set of company data based on the industry profile, the second set of company data reflecting the business opportunity in the target market. The method may further include summarizing the first set and the second set of company data based on the business characteristics associated with the target market, and presenting the business opportunity in the target market based on the one or more business characteristics.

### TECHNICAL FIELD

The present disclosure generally relates to methods and systems for collecting and managing sales data and company data, and more particularly, to methods and systems for identifying business opportunities in a target market based on sales data and company data.

### BACKGROUND

Sales teams in large companies often face the challenge of identifying new business opportunities in target markets. Business opportunities may be any potentially lucrative venture for a business to pursue. For example, business opportunities may refer to potential sales opportunities in a specific market.

Identifying business opportunities in a market can be a difficult task. First, a company faces the challenges of identifying business opportunities by product categories for each customer or prospective customer in existing markets. A product category may be any grouping of products offered by the company. Although a company may create and maintain its own customer and sales databases, it usually does not have access to its competitors' sales data. Thus, it is difficult to attain a complete picture of a customer's spending patterns, such as the customer's annual total spending, on a specific product category. As such, the company may not have sufficient information to identify business opportunities by product categories for each customer or prospective customer.

Further, the company may also have difficulty assessing business opportunities for current and prospective customers in a relatively new market. Because a company often only has access to its own customer data and sales data, it often does not have sufficient business intelligence to identify the needs of prospective customers in a new market. For example, when the company has a small market share in a specific market or plans to enter a new market, it would have insufficient internal customer data or sales data on which to base its market analysis or to assess business opportunities.

Many systems and methodologies have been developed to identify business opportunities based on customer characteristics. For example, U.S. Patent Application No. 2004/0122725 by Womack et al. discloses a method for managing customers by conducting behavior examination for one or more customers based on a recency factor, a frequency factor, and a monetary factor. The method includes assigning the one or more customers into a segment set based on a score. The score includes a value associated with the recency factor, the frequency factor, and the monetary factor. The method further includes assessing a customer's needs through a qualitative assessment and a quantitative assessment, and generating a strategic marketing plan based on the customer segmentation and the assessment.

While conventional systems and methods may provide some mechanism for managing customer data, they are often limited by specific data sources and rules used to organize the customer data. Further, conventional systems often focus on managing customers' data and sales based on a fixed set of business rules, and therefore do not provide a solution that enables a business to identify business opportunities with flexibility and accuracy.

Therefore, there is a need to provide a process for identifying sales opportunities for a company with flexibility and accuracy. The disclosed embodiments improve upon prior art systems by providing a system that enables a business to identify business opportunities in a target market based on customer data and industry profiles.

### SUMMARY

Systems and methods are disclosed for identifying business opportunities in a target market. In one embodiment, a business manager may implement a business opportunity management architecture to define a target market based on one or more business characteristics. The business manager may then collect a first set of company data for companies associated with the target market and build an industry profile associated with the target market based on the first set of company data. The business manager may further generate a second set of company data based on the industry profile, the second set of company data reflecting business opportunities in the target market. The business manager may then summarize the first set and the second set of company data based on the business characteristics associated with the target market, and present the business opportunities in the target market based on the one or more business characteristics.

### BRIEF DESCRIPTION OF THE DRAWINGS

The accompanying drawings, which are incorporated in and constitute a part of this specification, illustrate exemplary embodiments and, together with the description, serve to explain these disclosed embodiments. In the drawings:

FIG. 1 is a block diagram of an exemplary business opportunity management architecture consistent with certain embodiments of the present disclosure;

FIG. 2A is a flow chart of an exemplary business opportunity management process consistent with certain embodiments of the present disclosure;

FIG. 2B is an exemplary industry profile consistent with certain embodiments of the present disclosure;

FIG. 2C is another exemplary industry profile with a corresponding sales profile consistent with certain embodiments of the present disclosure;

FIG. 3A is another flow chart of an exemplary business opportunity management process consistent with certain embodiments of the present disclosure; and

FIG. 3B is an exemplary presentation of identified business opportunities in a target market consistent with certain embodiments of the present disclosure.

### DETAILED DESCRIPTION

Reference will now be made in detail to the disclosed embodiments, examples of which are illustrated in the accompanying drawings. Wherever possible, the same reference numbers will be used throughout the drawings to refer to the same or like parts.

In this disclosure, a company may be any individual or organization having business dealings with another business enterprise. A sales organization may be a sales department within a business enterprise, such as a dealership or a network of dealerships. A sales organization may also be a business entity dedicated to selling products and/or services. Business opportunity management (“BOM”) refers to the business activities related to managing data and business dealings of one or more companies to identify, develop, and obtain business opportunities in one or more target markets.

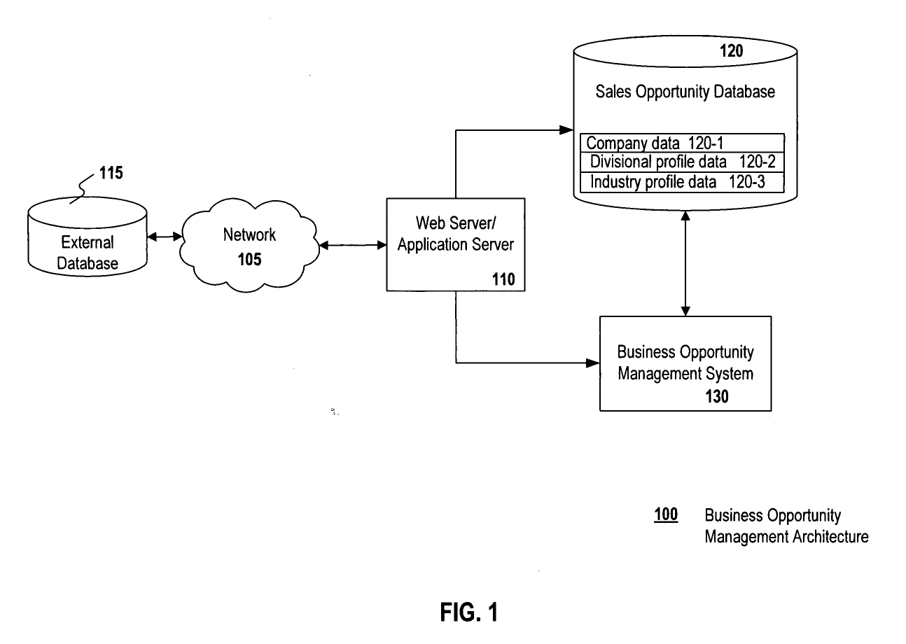

FIG. 1 shows a block diagram illustrating an exemplary BOM architecture 100 consistent with certain disclosed embodiments. BOM architecture 100 may be a computer system including, for example, a Web server/application server module 110, a sales opportunity database 120, one or more external databases 115, and a BOM system 130. Web server/application server module 110 interfaces with a network 105 and is also connected to sales opportunity database 120 and BOM system 130. It is contemplated that BOM architecture 100 may include some, all, or additional components other than those illustrated in FIG. 1. For example, BOM architecture 100 may include a user. In one embodiment, a user of BOM architecture 100 may be a business manager using the system to estimate certain sales opportunities. In another embodiment, a user of BOM architecture 100 may be an external software program requesting data from one or more components of BOM architecture 100.

Network 105 may be any type of wireline or wireless communication network for exchanging or delivering information or signals, such as the Internet, a wireless local area network (LAN), or any other network. Thus, network 105 may be any type of communications system. For example, users and systems of BOM architecture 100 may send or receive data using network 105.

Web server/application server module 110 may be a computer system configured to perform certain processes consistent with the disclosed embodiments. Web server/application server module 110 may include any type of web server and/or application server software, such as the Apache HTTP Server from the Apache Software Foundation. Web server/application server module 110 may include an interface device (e.g., a graphical user interface) for a user of BOM architecture 100, such as a business manager, to access external databases 115, sales opportunity database 120, and/or BOM system 130. A business manager may be a person who is responsible for managing the sales organization's data and identifying business opportunities in one or more markets. A business manager may manage business opportunities by accessing and analyzing company data and sales data from sales opportunity database 120 and/or one or more external databases 115.

Web server/application server module 110 may include additional software/hardware components, such as collaboration tools (e.g., Microsoft Exchange Server 2003) that permit users (e.g., business managers) to share data, bulletin boards that permit business managers to communicate with each other, and/or search engines to provide efficient access to specific entries in sales opportunity database 120, external databases 115, and/or BOM system 130. Web server/application server module 110 may also implement software that allows business managers to submit records to be added to sales opportunity database 120. Thus, web server/application server module 110 may include one or more software and/or hardware components that enable a user or software process to manage information contained in BOM architecture 100.

Sales opportunity database 120 and external database 115 may be systems including hardware and/or software executed by a processor that is configured to store company data and sales data records, charts, entries for changes made to the records, and other information used by one or more components of BOM architecture 100. For example, sales opportunity database 120 may include one or more memory devices and/or memory controllers. Sales opportunity database 120 may be implemented and maintained by a company that implements BOM architecture 100.

External database 115 may be any type of database created and managed by a third party, such as a commercial business intelligence data provider, an industry association, or a government entity. External database 115 may include data from one or more external data sources. External database 115 may include business data of various industries. For example, external database 115 may provide company data, such as a company's ownership information, address, headquarters, etc. External database 115 may also provide transactional data from individual companies, such as a company's equipment purchases in the past year. The third party maintaining external databases 115 may generate data records by cataloging a large number of phone books, annual reports, and other business directories to collect information on a large number of businesses. For example, the third party's staff members may hand-key data and call every business to verify the reliability of the collected data. The third party may also supplement the collected business data with private or public data records from commercial or public data sources, such as a commercial business data provider, or county courthouse filings, SEC 10k filings, etc. In one embodiment, external database 115 may include data from InfoUSA's business information database, which is maintained and updated by InfoUSA.com Inc.

BOM architecture 100 may include one or more sales opportunity databases 120 and external databases 115. In one embodiment, dealership A may implement BOM architecture 100 including a sales opportunity database 120 and external database 115. Sales opportunity database 120 may be created and managed by dealership A. Sales opportunity database 120 may include all dealership A's customer data related to their business dealings with this client. As shown in FIG. 1, sales opportunity database 120 may include one or more company data records 120-1. Company data records 120-1 may include any type of information describing the business operations of a company. For example, in the example of dealership A, each of dealership A's customers may be associated with one or more company data records 120-1. The company data 120-1 may include data reflecting the customers' nature of business and their business dealings with dealership A. Company data records 120-1 may be created based on internal sales data of dealership A and/or data provided by one or more external databases 115.

Company data 120-1 may associate one or more industry codes with a company. An industry code may refer to a classification system that categorizes products/services provided by a business. An industry code may be defined by a government entity or a private entity. Examples of such classification systems are the North American Industry Classification System (NAICS) and the U.S. Standard Industrial Classification (SIC) system, etc. For example, company data 120-1 may indicate that a company B may be a general building contractor with an SIC code of 1541. Company data 120-1 may also indicate that a company C may be a landscape contractor with an SIC code of 0782.

Company data 120-1 may also reflect the customer's purchases of various products. For example, company data 120-1 may include a company's past purchases of new product A from dealership A. Further, company data 120-1 may indicate dealership A's branch office and/or sales representatives from whom the company purchased product A.

Sales opportunity database 120 may also include one or more divisional profile data records 120-2. Divisional profile data 120-2 may include any type of business metric or statistics that describe the characteristics or behaviors of one or more companies related to the purchase or rental transactions of certain groups of products. A division may be defined as any grouping of products. In one embodiment, all purchases for certain new construction equipment manufactured by one or more manufacturer may be grouped in a “new equipment” division; all re-sell construction equipment may be grouped in a “used equipment” division; and all rental transactions for construction equipment may be grouped in a “rental equipment” division.

Sales opportunity database 120 may also include one or more industry profile data records 120-3. Industry profile data 120-3 may include any type of business metric or statistics that describe the characteristics or behaviors of companies within a certain industry. An industry may include businesses associated with one or more industry codes. Also, a business manager may use BOM architecture 100 to create one or more industry profile data records 120-3.

For example, a business manager may define an industry profile data record 120-3 for a group of landscape contracting companies (i.e., SIC code 0782). The industry profile data record 120-3 for the landscape contractors may include information such as the sales volumes of various machines, company headquarters locations, etc., for the landscape contractors. The business manager may use BOM system 130 to build the industry profile data 120-3 based on company data 120-1, as well as data from one or more external databases 115. The business manager may also use BOM architecture 100 to associate one or more company data records 120-1 to one or more industry profile data records 120-3. In the example of the industry profile for the landscape contractors, the business manager may associate all company data records 120-1 with an SIC code of 0782 to the landscape contractor industry profile data record 120-3.

In one embodiment, a business manager may use sales opportunity database 120 or web server 110 to cross-reference data retrieved from external database 115, such as mapping sales data on a geographical map. For example, external database 115 may provide geographical or other map data such as street map data. External database 115 may also provide company data 120-1, which may include headquarter location and branch office locations, for Company A. External database 115 may further provide business transaction data with respect to Company A's purchases of Machine A. The business manager may then use web server 110 or sale opportunity database 120 to map each purchase of Machine A made by Company A into a specific geographical location based on the map data, the Company data 120-1 and transaction data retrieved for Company A. The business manager may then use web server 110 to present the transactions of Company A on a geographical map.

BOM system 130 may be a computer system or software stored on one or more memory devices and executed by a processor that is configured to provide access to data stored in sales opportunity database 120 and external databases 115. BOM system 130 may receive one or more requests through web server/application server module 110. Based on the request, BOM system 130 may define, create, access, update, and/or delete data records stored in sales opportunity database 120 to perform business opportunity management functions.

BOM system 130 may include a decision support system. The decision support system may be a software program executed to analyze data (e.g., company data records 120-1) using a set of rules. BOM system 130 may include software programs implementing one or more BOM methods, such as a sales opportunity identification method. Based on data analysis results, BOM system 130 may implement processes according to the sales opportunity identification method and recommend user actions.

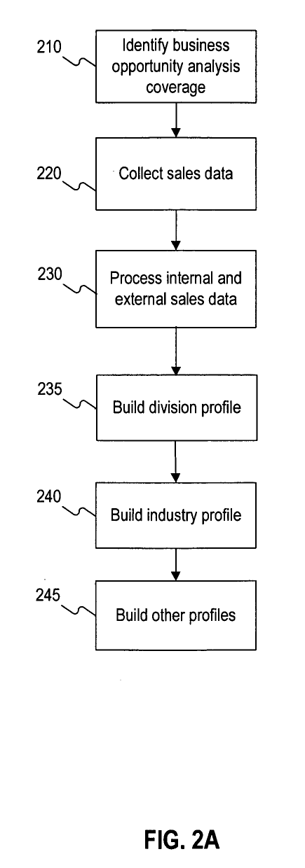

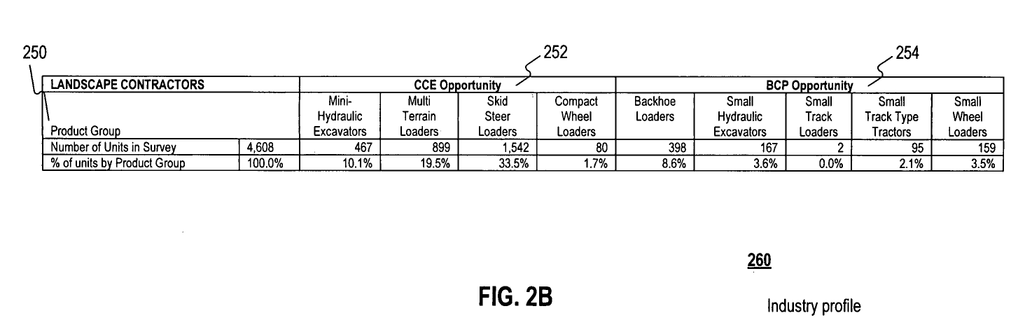

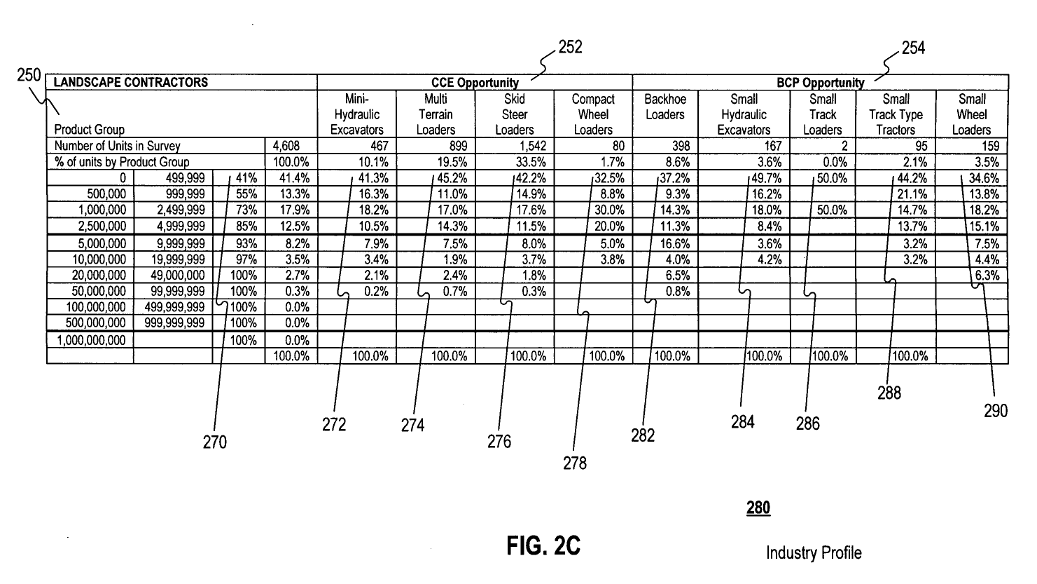

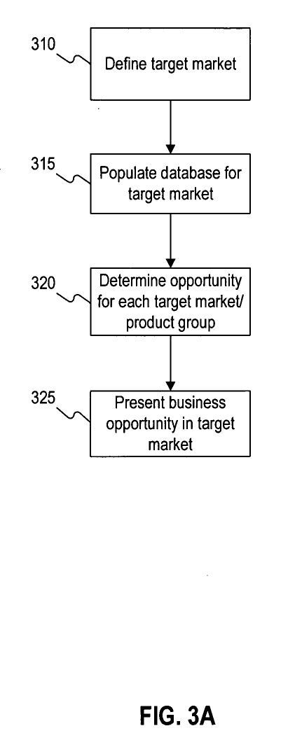

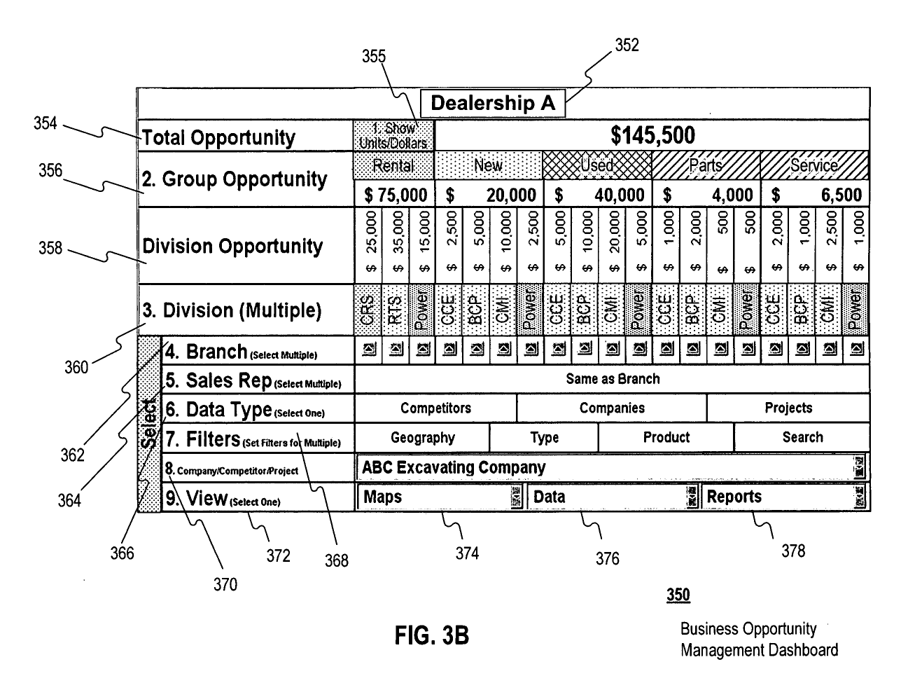

In one embodiment, the sales opportunity identification method implemented by BOM system 130 may include two subprocesses. First, a business manager may use BOM system 130 to collect company data 120-1, define a divisional profile 120-2, and build industry profiles 120-3. Second, based on company data 120-1 and industry profile data 120-3, the business manager may use BOM system 130 to identify business opportunities in target markets. These processes are further described in FIGS. 2A and 3A below.

FIG. 2A is a flow chart of an exemplary process for managing business opportunities consistent with certain disclosed embodiments. A business opportunity may refer to a sales opportunity or any other opportunity for a company to increase its revenue. A business opportunity may be estimated based on sales data and/or simulated sales data, such as customers' past spending, sales volume, size of target market, or estimated spending in a target market.

In one embodiment, a user (e.g., a business manager) of a business organization may use BOM system 130 to first define the coverage area for the business opportunity analysis supported by BOM architecture 100 (step 210). For example, the business manager may specify, in BOM system 130, that the business opportunity analysis coverage includes construction equipment sales to all residential and commercial construction contractors in three states.

The business manager may then use BOM system 130 to determine data sources and collect data, such as company data 120-1 from internal data sources (e.g., the business organization's own sales groups) and from external databases 115 (step 220). Based on the coverage of business opportunity analysis, the business manager may determine whether to collect sales data from internal sales departments and dealerships. The business manager may also use BOM system 130 to determine which external databases 115 may be accessed to collect data for the required business opportunity analysis. For example, external database A (115) may provide more complete new equipment sales data than others. The business manager may thus determine to request new equipment sales data from external database A (115). The business manager may save collected business data as company data records 120-1. The business manager may further use BOM system 130 to organize company data 120-1 based on information such as past sales revenues, projected/planned purchases, SIC codes, service preferences, business locations, etc.

In one embodiment, a business manager working for dealership A, which sells construction equipment, may collect company data 120-1 from various branch offices. Company data 120-1 may include sales data from all customers. Each company data record 120-1 may include an SIC code that indicates the type of business of the customer. A company data record 120-1 may further include data reflecting the units of various machines purchased by the company over a period of time. For example, company data 120-1 may indicate that customer A has purchased one mini-hydraulic excavator and one skid steer loader in the past twelve months. Dealership A may also collect sales data of its competitors from an external database 115. Dealership A may further collect more information about the nature of business of its customers (e.g., all office locations, purchases in other markets) from an external database 115.

Next, BOM system 130 may match and process the internally collected company data 120-1 with the externally collected company data (step 230). BOM system 130 may also populate more company data records 120-1 to ensure that sales opportunity database 120 contain sufficient data to build one or more division profiles 120-2 and industry profiles 120-3.

For example, dealership A's internal data may not show the SIC code associated with customer A, while the data collected from an external database 115 may indicate that customer A is a landscape contractor (SIC code 0782-03). The business manager may then use BOM system 130 to add the SIC code information in company data 120-1 associated with customer A. Further, data collected from external database 115 may include competitor information, indicating that customer A purchased various machines from other dealers/manufacturers. For example, customer A may have purchased a multi-terrain loader from one of dealership A's competitors. The business manager may use BOM system 130 to create new entries of company data 120-1 and store this sales information associated with customer A.

After processing the internal and external data from external databases 115 and sales opportunity database 120, the business manager may use BOM system 130 to define or build one or more division profiles 120-2 (step 235). A division may refer to any grouping of products and/or services. In one embodiment, the business manager may use BOM system 130 to define a division profile 120-2 to include new equipment purchases, such as the number of new construction machines purchased or the total amount of spending in the past twelve months in a few states or in the whole country. The business manager may build similar division profiles 120-2 for used and rental equipment.

After processing the internal and external data from external databases 115 and sales opportunity database 120, the business manager may use BOM system 130 to build industry profiles 120-3 (step 240). In one embodiment, an industry may be defined as companies with a set of SIC codes. Alternatively, the business manager may use BOM system 130 to build an industry profile for companies associated with a single SIC code. The business manager may use BOM system 130 to first group company data records 120-1 based on their corresponding SIC codes. The business manager may then use BOM system 130 to build industry profiles 120-3 based on one or more division profiles 120-2, each industry profile 120-3 describing the characteristics (within one or more product or service divisions) of the industry.

For example, the business manager may use division profile 120-2 and the target market defined by the business manager in step 210 to first determine the purchasing behavior for a division, such as the new construction equipment, in the target market. The business manager may then use BOM system 130 to analyze SIC codes of companies to determine an industry profile based on the divisional profile 120-2 and the defined target market.

Returning to the example of customer A, the business manager may build an industry profile 120-3 within a division based on a division profile 120-2 for all landscape contractors (SIC code 0782). BOM system 130 may then group all company data records 120-1 under the SIC code 0782. The industry profile 120-3 may include a variety of business information for the landscape contractors. For example, industry profile 120-3 may indicate the geographic distribution of the company headquarters and branch offices. Industry profile 120-3 may also reflect the purchase patterns of this group of landscape contractors.

FIG. 2B shows an exemplary industry profile 260 consistent with certain embodiments of the present disclosure. As shown in FIG. 2B, referring to the example of the landscape contractors, BOM system 130 may be used to aggregate sales volumes, such as the total number of units (or the total dollar amount) of various new machines sold during the past twelve months, for companies grouped in the industry profile (i.e. an industry profile based on the new equipment division profile 120-2). For example, BOM system 130 may categorize the sales volume of 4608 units for the group of landscape contractors into nine product groups (250): mini-hydraulic excavators, multi-terrain loaders, skid steer loaders, compact wheel loaders, backhoe loaders, small hydraulic excavators, small track loaders, small track-type tractors, and small wheel loaders. BOM system 130 may group the units sold in the first four product groups as the Compact Construction Equipment (CCE) sales opportunity (252) and those in the other five product groups as the Building Construction Products (BCP) sales opportunity (254). BOM system 130 may develop similar industry profiles 120-2 for landscape contractors for the Rental or Resale divisions (i.e., based on the rental equipment profile or the resale equipment profile).

Further, as shown in FIG. 2B, after summarizing company data records 120-1 associated with the industry profile 120-3, BOM system 130 may determine that of all the units of new machines purchased by this group of landscape contractors, 467 (10.1%) are mini-hydraulic excavators; 899 (19.5%) are multi-terrain loaders; 1,542 (33.5%) are skid steer loaders; 80 (1.7%) are compact wheel loaders; 398 (8.6%) are backhoe loaders; 167 (3.6%) are small hydraulic excavators; 2 (0%) are small track loaders; 95 (2.1%) are small track-type tractors; and 159 (3.5%) are small wheel loaders. BOM system 130 may store the percentage of purchases for each product group as part of the industry profile data 120-3.

Next, after processing company data records 120-1 to build an industry profile 260 as shown in FIG. 2B, to manage business opportunities in target markets, a business manager may use BOM system 130 to further build a more detailed industry profile by sales volume. In addition, BOM system 130 may use a transition table to equalize market values defined in 320 to the industry profiles 120-2 or convert market opportunity values defined in 320 by product group to product group values in industry profile 120-2. FIG. 2C shows an exemplary industry profile by sales volume 280 consistent with certain embodiments of the present disclosure. As shown in FIG. 2C, referring to the example of the landscape contractors, the business manager may use BOM system 130 to summarize sales transactions, such as units of new machines sold, for one or more subsets of companies in the industry profile. After building the industry profile 120-3 and further apportioning the units of machines sold to subsets of companies in the industry, BOM system 130 may present an industry profile or an industry profile by sale volume to the business manager through a user graphic interface.

As shown in FIGS. 2B and 2C, referring to the example of the landscape contractor profile, BOM system 130 may categorize sales volumes for multiple product groups, such as mini-hydraulic excavators, multi-terrain loaders, skid steer loaders, compact wheel loaders, backhoe loaders, small hydraulic excavators, small track loaders, small track-type tractors, and small wheel loaders. BOM system 130 may group various product groups under CCE sales opportunity (252) and BCP sales opportunity (254). BOM system 130 may use one or more transition tables to group the landscape contractor companies according to various business metrics and display the purchasing pattern for each group of companies.

As shown in FIG. 2C, BOM system 130 may group the landscape contractor companies according to their sales revenues of the CCE and BCP products. For example, 41% (270) of the total units were purchased by the landscape contractors whose sales were between $0 and $500,000. Further, the sales profile shows that, in the past twelve months, this group of contractors purchased 41.3% of the mini-hydraulic excavators (272), 45.2% of the multi-terrain loaders (274), 42.2% of the skid steer loaders (276), 32.5% of the compact wheel loaders (278), 37.2% of the backhoe loaders (282), 49.7% of the small hydraulic excavators (284), 50.0% of the small track loaders (286), 44.2% of the small track type tractors (288), and 34.6% of the small wheel loaders (290).

Referring back to FIG. 2A, similar to the process of building the industry profile 120-2, the business manager may also use BOM system 130 to build one or more other profiles, such as project profiles, based on data collected from internal and external databases (step 245). A project may be any kind of business undertaking, such as a construction project, a road-building project, etc. A project profile may include any type of statistics or metrics that describe the characteristics of a project. For example, the business manager may build a project profile for large landscape projects. Similar to the industry profile shown in FIG. 2C, the large landscape project profile may reflect the units of various types of machines purchased by the contractors for the particular type of project.

After collecting customer data records 120-1, and building industry profile 120-3 and the corresponding sales profiles, the business manager may then use BOM system 130 to determine business opportunities in one or more target markets based on customer data 120-1, industry profile 120-3, and/or the project profiles. FIG. 3A shows an exemplary process of determining business opportunities in target markets consistent with certain disclosed embodiments of the present disclosure.

As shown in FIG. 3A, first, to determine business opportunities in a target market, a business manager may use BOM system 130 to define the target market (step 310). The target market may be defined by any one or more business rules supported by BOM system 130. The target market may be defined by one or more SIC codes, dealership locations, product groups, etc.

For example, a business manager working for dealership A may define the geographic area (e.g., one state) covered by dealership A as the target market. Further, the business manager may define that the target market only includes certain product divisions, such as the CCE division, which may include different types of products. A product division may be defined as any grouping of products based on one or more characteristics of the products. For example, the CCE (compact construction equipment) product division may include mini-hydraulic excavators, multi-terrain loaders, skid steer loaders, and compact wheel loaders.

The business manager may further define the target market to only include companies from certain industries. For example, dealership A may offer CCE products in three states. The business manager may define a target market as the market for all new CCE products sales to all landscape contractors in the three states.

Next, the business manager may use BOM system 130 to load and populate data into sales opportunity database 120 (step 315). In one embodiment, referring to the above example of dealership A, the business manager may use BOM system 130 to build a landscape contractor profile 120-3 (see FIG. 2C). However, sales opportunity database 120 may not contain data for all landscape contractors in the three states of dealership A's market. To determine business opportunities in the target market, the business manager may need company data that describe sales in the target market. The business manager may collect data from one or more internal and/or external data sources to populate sales opportunity database 120. The business manager may also use BOM system 130 to generate company data records 120-1 for companies in the target market based on one or more industry profiles 120-3 to populate sales opportunity database 120.

In one embodiment, the business manager may collect data from one or more external databases 115 to obtain company information for all landscape contractors in the defined target market. If some of the landscape contractors have incomplete sales data, BOM system 130 may need to generate sales data for these companies. BOM system 130 may generate company data and sales data based on the landscape contractor profile (FIG. 2C) and store the generated data as company data records 120-1 in sales opportunity database 120. For example, the collected company data associated with landscape contractors with spending between $0 and $500,000 on the nine product groups as shown in FIG. 2C may show that the group has purchased fewer than 41.3% of the total mini-hydraulic excavators. BOM system 130 may then generate one or more sales data records for mini-hydraulic excavators for one or more landscape contractors in this group.

Returning to FIG. 3A, after populating sales opportunity database 120 with collected and/or generated company data records 120-1 for the target market, the business manager may use BOM system 130 to determine business opportunities for the defined target market (step 320). The business manager may use BOM system 130 to determine business opportunities in the target market by aggregating company data 120-1 according to one or more division profiles 120-2. The business manager may also use BOM system 130 to correct one or more industry profiles 12-3 to more accurately reflect the characteristics of the target market.

For example, BOM system 130 may define business opportunities in a second market (e.g., the target market as defined in step 310) as a function of customers' past spending or estimated future spending in a first market (i.e., projecting business opportunities in the second market based on an industry profile 120-3 built based on data in the first market). In one example, the first and the second markets may each refer to a different geographical area. BOM system 130 may correct one or more industry profiles 120-3 to reflect the difference in the two markets. In one embodiment, the first market may have an industry profile 120-3 for landscape contractors, which indicates that these companies purchase 10.1% of units in certain product groups. For example, the industry profile 120-3 may indicate that landscape contractors purchase 10.1% of the total 467 mini-hydraulic excavators (e.g., see FIG. 2C) that will be sold in the first market.

However, the second market (e.g., the target market in the example above or a state not located in the first market) may not have any company in the same industry. For example, the second market may not have a landscape contractor company. BOM system 130 may then adjust the industry profiles 120-3 for other industries (e.g., construction companies, mining companies, etc.) in the second market so that the total units that are/will be purchased in the market may be apportioned to other industry profiles 120-3. In the example of mini-hydraulic excavators, for the second market, BOM system may re-apportion the 47 units (10.1% of 467) originally apportioned to landscape contractors (based on the industry profile 120-3 for landscape contractors in the first market) to other industries, such as construction companies, mining companies, etc.

After determining business opportunities for one or more industries based on one or more industry profiles 120-3 in a target market, BOM system 130 may then present the business opportunities in certain product divisions to the business manager through a graphical user interface (step 325).

In one embodiment, dealership A, a construction equipment dealer, may offer to sell rental products, new products, used products, and parts and services in three states. The business manager may then define a target market as the market for all products and services offered to all landscape contractors in the three states. The business manager may further determine the business opportunities in the target market for the next twelve months based on company data 120-1 reflecting the sales revenue of the past twelve months. In one embodiment, the business manager may believe that since the market conditions are stable, the sales revenue for the future twelve months may be very close to that of the past twelve months (e.g., business opportunity=past twelve months' sales revenue).

Further, the business manager may desire to present the business opportunities in the target market by each product division, or based on one or more geographical areas. FIG. 3B shows an exemplary BOM dashboard 350 for dealership A for the target market consistent with certain embodiments of the present disclosure. A dashboard may be any type of data presentation that consolidates, aggregates, and arranges measurements, metrics, and/or scorecards on a single view so information can be monitored easily.

As shown in FIG. 3B, the top line 352 of the BOM dashboard 350 may show the name of the sales organization to which the business manager belongs. Referring to the example of dealership A, the business manager may be an employee of dealership A (352). The second line 354 of the BOM dashboard 350, labeled “Total Opportunity,” may show an aggregate total of the business opportunity value for all the product groups and divisions in the defined target market. Additionally, a “Show Units/Dollars” link 355 may be provided. If link 355 is clicked, the BOM dashboard 350 is reloaded and the dollar opportunity values can be replaced with the number of units corresponding to the business opportunities in the target market. In the example of dealership A, as shown in FIG. 3B, the target market (for all new rental products, new products, used products, and parts and services offered to all landscape contractors in the three states) may have a total business opportunity in the amount of $145,500.

Next, the third line 356 of the BOM dashboard 350, labeled “Group Opportunity”, may contain “Rental,” “New,” Used,” “Parts,” and “Service” headings with aggregate totals of the opportunity value (or units) for each of the divisions selected within each group. If a heading link is clicked, the group aggregate value (or units) would be removed, all division opportunity 358 values (or units), divisions 360, branch options 362, and sales representative options 364 within the group would be disabled. The total opportunity 354 aggregate value (or units) may then be updated to exclude the business opportunity value from the disabled group. In the example of dealership A, in the target market, the group opportunity 356 for all rental products is $75,000; the group opportunity for all new product sales is $20,000; the group opportunity for all used product sales is $40,000; the group opportunity for parts sales is $4,000; and the group opportunity for all service sales is $6,500.

Next, in FIG. 3B, the fourth line 358 of the BOM dashboard 350, labeled “Division Opportunity,” may contain the business opportunity values (or units) for each of the product divisions within each group. The fifth line 360 of the BOM dashboard 350, labeled “Division,” contains the division headings for each of the groups. As explained earlier, a product division such as the CCE division may include one or more products. If a division heading link is clicked, the corresponding division opportunity value (or units) would be removed and grayed out, the corresponding branch 362 and sales representative 364 options would also be grayed out and disabled. The group opportunity 356 aggregate value (or units) may be updated to exclude the opportunity value (or units) for the disabled product division. The total opportunity 354 aggregate value (or units) may also be updated to exclude the opportunity value (or units) for the disabled division. All the product division groups may be enabled by default.

In the example of dealership A, in FIG. 3B, division 360 and division opportunity 358 values (or units) are displayed for the following divisions:
The “Rental” group includes the CRS (Company A rental store products) division with an identified business opportunity of $25,000, the RTS (Rent to sale) division with an identified business opportunity of $35,000, and the power (power generators) division with an identified business opportunity of $15,000.
The “New” group includes the CCE division with an identified business opportunity of $2,500, the BCP division with an identified business opportunity of $5,000, the CMI (construction and mining industry) division with an identified business opportunity of $10,000, and the Power division with an identified business opportunity of $2,500.
The “Used” group includes the CCE division with an identified business opportunity of $5,000, the BCP division with an identified business opportunity of $10,000, the CMI division with an identified business opportunity of $20,000, and the Power division with an identified business opportunity of $5,000.
   As shown in FIG. 3B, BOM system 130 may also present the identified business opportunities for the “Parts” group and the “Service” group for similar product divisions.

Next, the sixth line 362 of the BOM dashboard 350, labeled “Branch,” may contain a clickable image option (up arrow) for each product division in each group. Each branch may refer to a branch office in dealership A. For example, if an option is clicked from one of the divisions of the “Rental,” “New” or “Used” groups, a branch office selection would appears on the page. If one or more branch office options are selected, the division opportunity 358 value (or units), group opportunity 356 value (or units), and the total opportunity 354 value (or units) would be updated to include only the amounts of business opportunities for the selected branch or branches. The geography (368) is automatically filtered to only include the selected branch office territories. The competitors, companies, or projects available in the “Data Type” list section of line ten 366 of the BOM dashboard 350 would be updated to those that fall within all branch territories.

The seventh line 364 of the BOM dashboard 350, labeled “Sales Representative,” may contain a clickable image option (up arrow) for each division in each group. For example, if an option is clicked from within the divisions of the “Rental,” “New” or “Used” groups, the sales representative selection would appear on the page. If one or more sales representative options are selected, all other sales representative options, branch options (except the one in the same division), divisions 360, division opportunity 358 values (or units), and group opportunity values (or units) 356 are disabled. The division opportunity 358 value (or units), group opportunity 356 value (or units), and the total opportunity 354 value (or units) would be updated to include only the amounts for the selected sales representative or sales representatives. The geography (368) is automatically filtered to only include the selected sales representative territories. The competitors, companies, or projects available in the “View” list section of the eleventh line 372 of the BOM dashboard 350 would be automatically filtered to only those that fall within the selected sales representative territories.

In the example of dealership A, the business manager may thus select various branch offices 362 and sales representatives 364 to determine business opportunities for their specific geographic locations. For example, the business manager may select a branch office A and a sales representative B in branch office A. The BOM dashboard 350 would then display the division opportunity 358 in the area covered by branch office A and sales representative B.

Next, the eighth line 366 of the BOM dashboard 350, labeled “Data Type”, may contain the “Competitors,” “Companies,” and “Projects” options. By default, the “Companies” data type may be selected. “Companies” may indicate that the business opportunities displayed is the summary of sales data from all companies in the target market. Selecting a data type option may change the underlying data source for the entire BOM dashboard 350. In the example of dealership A, if the business manager selects “competitors” in line 370, the BOM dashboard 350 may display the identified business opportunities based on sales data of dealership A's competitors.

Next, the ninth line 368 of the BOM dashboard 350, labeled “Filters,” may contain four options for filtering based on the data type selected. As shown in FIG. 3B, for Competitors/Companies/Projects, the four filter options are: “Geography,” “Type,” “Product,” and “Search.” The business manager may apply the filters to exclude the filtered records from being displayed on the BOM dashboard 350. Referring back to the above example of dealership A with a “Competitors” data type 366 view, for instance, the business manager may use the “Product” filter 368 to only select a few products for which the identified business opportunities would be displayed in the BOM dashboard 350.

The tenth line 370 of the BOM dashboard 350 may contain different values depending on the selected data type 366. For example, if the selected data type 366 is “Competitors,” the BOM dashboard 350 would display the available competitors list. The business manager may filter the data used for the BOM dashboard 350 to only include the competitor records selected from the list of competitors. In the example of dealership A, with a “Competitors” data type 366 view, for instance, the business manager may further select a subset of competitors from the competitors list, and update the BOM dashboard 350 to only present business opportunities corresponding to the selected competitors.

The eleventh line 372 of the BOM dashboard 350, labeled “View,” may include a “Maps” dropdown 374, a “Data” dropdown 376, and a “Reports” dropdown 378. If an option in the “Maps” 374 dropdown is selected, the BOM presentation page would be reloaded with the data set currently selected in the BOM dashboard 350 (with all filters applied), and then the data set would be loaded into a map view using the type of map selected. If the “Data” dropdown 376 is clicked, the presentation page would be reloaded with the data set currently selected in the BOM dashboard 350 (with all filters applied). The data set would be loaded into the corresponding data view (e.g., a competitor list, a company list, or a project list). If an option in the “Reports” dropdown 378 is selected, the presentation page would be reloaded with the data set currently selected in the BOM dashboard 350 (with all filters applied) and the report view selected.

Further, in one embodiment, a restore to defaults link may be displayed above the BOM dashboard 350, which may reset the BOM dashboard 350 to the default parameters as outlined in each section of the above description of the BOM dashboard 350.

### Industrial Applicability

Methods and systems consistent with the disclosed embodiments may enable a business to implement market centric business processes to identify and present business opportunities in a target market. By implementing disclosed embodiments, a business manager may collect company data and sales data from internal and external sources, and build industry profiles based on the collected data. Further, the business manager may track the trends in a target market by promptly updating company data and sales data, and using the BOM system to update the industry profiles according to the new data. As such, the business can obtain a more accurate view of the market, and its customers' spending.

Methods and systems consistent with the disclosed embodiments may also enable a business to generate simulated customer data and sales data in a market for which it does not have sufficient data. A business manager may collect company data from various data sources and then apply an industry profile to generate simulated sales data for the target market. The business manager may further present business opportunities in the target market based on the system-generated sales data.

Methods and systems consistent with the disclosed embodiments may further enable a business to present identified business opportunities in a target market with a customized approach. For example, a business manager may modify an industry profile to reflect special circumstances in the market that are not accounted for by the collected customer data and sales data. The business manager may then use the BOM architecture to generate simulated sales data based on the modified industry profile and present the identified business opportunity based on the generated sales data.

The implementation of the disclosed systems and methods are not limited to the architecture shown in FIG. 1. For example, a BOM architecture may be implemented by a single processor executing program codes to perform one or more of the processes disclosed herewith. It will be apparent to those skilled in the art that various modifications and variations of the disclosed embodiments can be made. Additionally, other embodiments of the disclosed methods and systems will be apparent to those skilled in the art from consideration of the specification. It is intended that the specification and examples be considered as exemplary only, with a true scope of the disclosure being indicated by the following claims.

What is claimed:

1. A method for identifying a business opportunity in a target market, comprising:
defining the target market based on one or more business characteristics;
receiving a first set of company data for companies associated with the target market;
building an industry profile associated with the target market based on the first set of company data;
generating a second set of company data based on the industry profile, the second set of company data reflecting the business opportunity in the target market;
summarizing the first set and the second set of company data based on the business characteristics associated with the target market; and
presenting the business opportunity in the target market based on the summarization of the first set and the second set of company data and the one or more business characteristics.

2. The method of claim 1, further comprising:
building a division profile associated with the first set of company data; and
building the industry profile based on the division profile.

3. The method of claim 1, wherein receiving the first set of company data for companies associated with the target market includes receiving the company data from a plurality of data sources.

4. The method of claim 3, wherein building the industry profile includes building the industry profile based on the first set of company data from at least two data sources.

5. The method of claim 4, wherein generating the second set of company data includes deriving sales data based on the industry profile.

6. The method of claim 1, wherein the one or more business characteristics include an industry code.

7. The method of claim 2, wherein presenting the business opportunity includes presenting the business opportunity based on one or more division profiles and industry profiles.

8. A computer system for identifying a business opportunity in a target market, the system including:
a processor; and
a memory storing data including customer data records, wherein the processor is configured to:
define the target market based on one or more business characteristics;
receive a first set of company data for companies associated with the target market;
build an industry profile associated with the target market based on the first set of company data;
generate a second set of company data based on the industry profile, the second set of company data reflecting the business opportunity in the target market;
summarize the first set and the second set of company data based on the business characteristics associated with the target market; and
present the business opportunity in the target market based on the one or more business characteristics.

9. The system of claim 8, wherein the one or more business characteristics include an industry code.

10. The system of claim 9, wherein the one or more business characteristics further include a product division.

11. The system of claim 8, wherein the processor is further configured to receive the company data from a plurality of data sources.

12. The system of claim 11, wherein the processor is further configured to build the industry profile based on the first set of company data from at least two data sources.

13. The system of claim 12, wherein the processor is further configured to generate the second set of company data by deriving sales data based on the industry profile.

14. The system of claim 10, wherein the processor is further configured to present the business opportunity based on one or more product divisions.

15. A computer-readable medium containing instructions to configure a processor to perform a method for identifying a business opportunity in a target market, the method comprising:
defining a target market based on one or more business characteristics;
receiving a first set of company data for companies associated with the target market;
building an industry profile associated with the target market based on the first set of company data;
generating a second set of company data based on the industry profile, the second set of company data reflecting a business opportunity in the target market;
summarizing the first set and the second set of company data based on the business characteristics associated with the target market; and
presenting the business opportunity in the target market based on the one or more business characteristics.

16. The method of claim 15, wherein the one or more business characteristics include an industry code.

17. The method of claim 15, wherein receiving the first set of company data for companies associated with the target market includes receiving the company data from a plurality of data sources.

18. The method of claim 17, wherein building the industry profile is based on the first set of company data from at least two data sources.

19. The method of claim 18, wherein generating the second set of company data includes deriving sales data based on the industry profile.

20. The method of claim 15, wherein the one or more business characteristics include a product division, and presenting the business opportunity further includes presenting the business opportunity based on one or more product divisions.
